(19) United States
(12) Patent Application Publication
(10) Pub. No.: US 2024/0017683 A1
(43) Pub. Date: Jan. 18, 2024

(54) BAFFLE WITH DRAIN PATH

(71) Applicant: Zephyros, Inc., Romeo, MI (US)

(72) Inventors: Jeffery T. Shantz, Romeo, MI (US); Gary I. Coltson, Romeo, MI (US)

(21) Appl. No.: 17/864,488

(22) Filed: Jul. 14, 2022

(51) Int. Cl. B60R 13/07

(52) U.S. Cl. CPC B60R 13/07

(57) ABSTRACT

A baffle, comprising: (a) a carrier having a downspout to direct a flow of moisture or fluid; and (b) a sealant material disposed on the carrier; wherein the downspout is located near a peripheral edge of the carrier and the downspout is free of contact with the sealant material.

### FIELD

The present invention generally relates to baffling materials, and more particularly, baffling materials having a drain path therein.

### BACKGROUND

Industries, such as the automotive industry, may often use various devices for baffling, sealing, or reinforcing. Such devices may be a member that often includes a sealant material disposed on, or otherwise connected to, the member. The member and sealant material may also include additional features which, when combined, form a seal, a baffle, a structural reinforcement, or a combination thereof in a cavity, such as a cavity of a vehicle.

Often times, a sealant material is at least partially applied over a carrier, such that the carrier may be inserted into a cavity and secured therein so that the carrier and sealant material may fill in any caps within the cavity and substantially conform to a contour of the cavity. As a result, the cavity may be sealed to substantially prevent debris, moisture, other contaminants, or a combination thereof from entering the cavity.

Unfortunately, while the baffling or sealing members may substantially follow a contour of the cavity being filled, there may often be imperfections such that the members do not perfect seal the cavity. Similarly, other gaps or voids may be present along the cavity not related to the member being inserted, thereby creating a potential entrance for debris, moisture, other contaminants, or a combination thereof. As a result, such particles or liquids may enter the cavity and potentially cause degradation of the vehicle body, one or more components (e.g., a wiring harness or other electrical component) located within the sealed cavity, or both.

Thus, there remains a need for a baffling and/or sealant material that better matches a contour of a cavity to improve sealing of the cavity. What is needed is a baffling material having a sealant material disposed near a periphery of the baffling material. Moreover, there remains a need for a baffling material the allows for drainage from within a cavity. What is needed is a baffling material having a drain spout.

### SUMMARY

The present teachings meet one or more of the present needs by providing a baffle, comprising: (a) a carrier having a downspout to direct a flow of moisture or fluid; and (b) a sealant material disposed on the carrier; wherein the downspout is located near a peripheral edge of the carrier and the downspout is free of contact with the sealant material.

The sealant material may be activatable and the downspout may be free of contact with the sealant material after activation of the sealant material. Additionally, the downspout may include: (a) an inlet ramp; (b) a channel in communication with the inlet ramp; and (c) an outlet located along the peripheral edge of the carrier in communication with the inlet ramp. Moreover, a flow direction of the moisture or the fluid may be from the inlet ramp through the channel so that the moisture or the fluid drains from the outlet.

The sealant material may be located along a periphery of the carrier and may be free of contact with a central portion of the carrier. The sealant material may be expandable upon activation. Moreover, the baffle may be configured to be positioned within a cavity and seal the cavity. Similarly, a shape of the baffle may substantially follow a contour of the cavity. Additionally, the carrier may further include a weldable tab. Similarly, the carrier may include intersecting ribs along a back surface of the carrier.

Moreover, the downspout may be formed by interconnecting opposing walls. The opposing walls may be substantially parallel to each other. The opposing walls may be angled relative to each other to form a taper. The taper may narrow along a bottom portion of the downspout away from an outer surface of the baffle. Additionally, the downspout may be positioned between weldable tabs and between steps formed in the carrier. Moreover, the downspout may be configured to be offset from a panel of a cavity to ensure proper drainage of the moisture or the fluid.

The sealant material may be secured to the carrier by one or more retaining features. The one or more retaining features may be a mechanical interlock. The one or more retaining features may be a hole having the sealant material at least partially extend therethrough.

The present teachings meet one or more of the present needs by providing: a baffling and/or sealant material that better matches a contour of a cavity to improve sealing of the cavity; a baffling material having a sealant material disposed near a periphery of the baffling material; a baffling material the allows for drainage from within a cavity; a baffling material having a drain spout; or a combination thereof.

### DESCRIPTION OF THE DRAWINGS

FIG. 1 is a top view of a baffle in accordance with the present teachings.

FIG. 2 is a side view of a baffle in accordance with the present teachings.

FIG. 3 is a bottom view of a baffle in accordance with the present teachings.

FIG. 4 is a perspective view of a baffle positioned within a cavity.

FIG. 5 is a close-up perspective view of a downspout of a baffle.

FIG. 6 is a close-up perspective view of a downspout of a baffle interacting with a panel.

### DETAILED DESCRIPTION

The explanations and illustrations presented herein are intended to acquaint others skilled in the art with the invention, its principles, and its practical application. The specific embodiments of the present invention as set forth are not intended as being exhaustive or limiting of the invention. The scope of the invention should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein are directed toward a baffle. The baffle may function to provide baffling to an article of manufacture. The baffle may also provide sealing, reinforcing, or both to an article of manufacture. The baffle may guide expansion of a sealant material, may deform to conform to one or more widths of a cavity into which the baffle is inserted, or both. The baffle may include a carrier and a sealant material may be disposed on the carrier. Thus, the carrier may have a predetermined shape to guide one or more expansion and/or flow directions of the sealant material. It is envisioned that the sealant material may be capable of being activated to expand under an activation condition to come into contact with—and adhere to—one or more panels defining a cavity in order to at least partially fill the cavity. The baffle may specifically be adapted to provide sealing, baffling, or reinforcement within a structure's cavity. The baffle may find a particular benefit in conforming variability in a cavity's width, such as variability due to tolerance stack-up and/or manufacturing variability. It is contemplated that the baffle may be applied (e.g., assembled) to various articles of manufacture such as boats, trains, buildings, homes, furniture, or the like. It has been found however, that the member may be particularly suitable for application in automotive vehicles.

The baffle may include a carrier. The carrier may function to affix the baffle to at least one surface, deform to allow the baffle to fit within a cavity smaller than the device's overall dimensions, provide a surface for carrying a sealant material, guide the expansion or flow of such sealant material, or a combination thereof. The carrier may have a longitudinal axis. The carrier may include one or more straight, curved, bent, or angled portions. The carrier may be rigid, flexible, or a combination of both rigid portions and flexible portions. The carrier may be flexible or have flexible portions and thus may be formed to facilitate movement of the carrier and/or the activatable material along more than one axis. The carrier may include portions having a material thickness that is greater than the material thickness of other portions of the carrier. The portions having a greater thickness may be arranged in a position that is substantially parallel to or substantially perpendicular to a portion having a smaller thickness. The carrier may have a first surface and a second surface. For example, the carrier may include an outer or front surface and a lower or back surface.

The carrier may be any desired material. It is envisioned that the carrier may provide structural rigidity to the baffle. Thus, it is contemplated that the carrier may be injection-molded, stamped, overmolded, extruded, die-cut, or otherwise formed. As a result, various materials may be used, such as polymers (e.g., polyamides, plastics, etc.), metals (e.g., steel, aluminum, iron, etc.), or a combination thereof.

The carrier may also include one or more strengthening features. The strengthening features may include one or more beads, one or more ribs, one or more gussets, one or more fins, or a combination thereof. The strengthening features may include localized increases in material thickness. If one or more ribs are presents, the ribs may extend from any surface of the carrier, may intersect, may be free or intersection, or a combination thereof. Additionally, the strengthening features, such as ribs, may be free of contact with sealant material prior to and/or after activation. Similarly, it is envisioned that the strengthening features may also provide secondary functionality. For example, the fins may project from an outer surface of the carrier to not only provide structural reinforcement, but also to at least partially direct a flow of moisture or fluid along the outer surface of the carrier. Moreover, the strengthening features may also aid in manufacturing and/or assembly of the baffle. For example, the strengthening features may facilitate automated manufacturing of the baffle by providing one or more contact points to pick-up, grab, move, contact, or a combination thereof the baffle. Similarly, such strengthening features may also provide points of contact for an installer of the baffle in a desired assembly without damaging the baffle.

The carrier may include a sealant material which may be located only onto select portions of the carrier. The sealant material may only be located on a first surface of the carrier, such as an outer surface. The sealant material may substantially enclose the entirety of the carrier. Alternatively, the sealant material may substantially enclose only portions of the carrier Similarly, the sealant material may form a border around a central portion of the carrier, whereby the sealant material is located only along or near a periphery of the carrier. The sealant material be located on both the first and second surface of the carrier (e.g., a front and back surface).

The sealant material may extend beyond an end of the carrier (i.e., beyond a point where the carrier terminates, such as beyond one or more peripheral edges). Alternatively, the sealant material may be substantially coextensive with an end of the carrier. Similarly, the sealant material may extend near an edge of the carrier without being coextensive with the carrier. For example, the sealant material may be positioned near an end of the carrier yet allow a lip formed along an edge of the carrier to be free of the sealant material.

Any portion of the carrier which forms a fastener or connection means with a cavity or secondary member may be substantially free of any sealant material. Such connection means may include one or more tabs located along the carrier. The tabs may function to secure the baffle to one or more surfaces (e.g., panels) within a cavity. Such connection may be formed by welding the tabs to the panels of the cavity. However, it is also envisioned that alternative or additional connection means may also be utilized.

For example, the carrier may include one or more projections. The projections may extend from any desired surface of the carrier to engage panels or surfaces of the cavity, such as a hole or mating portion of the panels or surfaces. Similarly, the projections may extend from the carrier to abut the surface or panels free of fixed connection. Thus, the projections may act as a standoff from the surface or panel being contact, thereby ensuring a proper position of the baffle within the cavity relative to the surface or panels being contacted.

The sealant material itself may be formed to have a curved profile, varying profile height, or the like. The sealant material may have a substantially uniform thickness or varying thickness. In the event that the sealant material is not co-extensive with the carrier, the sealant material that extends beyond an end of the carrier may be curved. Any angle of curvature of any portion of the carrier, the sealant material, or both may be selected based upon the intended location of the baffle, which may depend upon the shape of a cavity into which the baffle is to be located. The carrier and/or sealant material may be curved in a single direction or may be curved in multiple directions. The curve may form a substantially U-shaped or substantially V-shaped baffle.

The sealant material may be activatable. The sealant material may be an adhesive material, an expandable material, or both. Thus, the sealant material may be activated to adhere to one or more surfaces, to expand, or both. Similarly, the sealant material may adhere at a different activation temperature than when expansion occurs.

The sealant material may have an expansion surface and an adhesion surface. The adhesion surface may be the surface of the sealant material adhered to a surface of the carrier. The adhesion surface may have substantially the same profile or contours as the surface of the carrier onto which it is adhered. The expansion surface may be the opposing surface of the expandable material, opposite from the adhesion surface. The expansion surface may have substantially the same profile or differing profile as the profile of the carrier. The expansion surface may have a generally uniform profile or a varying profile (i.e. including contours, curves, varying thicknesses, etc). The expansion surface may be substantially coplanar with an outer surface of the carrier, may be recessed from the outer surface of the carrier, may extend beyond an outer surface of the carrier, or a combination thereof. Additionally, the expansion surface may be placed at an angle relative to the desired expansion direction of the sealant material, such as generally perpendicular to the expansion direction, to guide expansion of the sealant material. It is envisioned that expansion and or flow of the sealant material may be guided or otherwise directed to engage surfaces of the cavity, thereby sealing the cavity.

Portions of the carrier may be located in different planes from one another. Thus, one or more surfaces of the carrier may be at an angle generally perpendicular to the expansion or flow direction of the sealant material. The one or more surfaces of the carrier may guide expansion or flow of the sealant material by being generally perpendicular to the expansion or flow direction.

The carrier may include retaining features which aid in retaining the sealant material on the carrier. The retaining features may be any number of structures, such as a mechanical interlock. For example, the mechanical interlock may be an interference fit between the sealant material and the carrier or may otherwise be interlocked using a mechanical joint (e.g., a dovetail joint). Similarly, the sealant material may at least partially extend through a portion of the carrier. For example, the sealant material may extend through one or more holes in the carrier to engage the holes. In doing so, a position of the sealant material may not only be maintained, but a flow or expansion of the sealant material through the holes upon activation may further secure the sealant material to the carrier.

It is envisioned that the baffle may be positioned within a cavity to seal the cavity from debris, moisture, or both. In such a case, it may still be possible for moisture or liquid to enter the cavity through various imperfections, holes, or other entrances not directly influenced by the baffle. In such a case, it is particularly beneficial that the baffle may include a downspout.

The downspout may function to at least partially direct moisture or liquid within the cavity to a desired exit point. The downspout may be positioned along the carrier, formed in the sealant material, or both. The downspout may be positioned to guide a fluid (i.e., water or oil) through the cavity or along the surface of the baffle to an exit point of the cavity.

The downspout may include an inlet ramp. The inlet ramp may be an initial guide to create a flow direction of the fluid. The inlet ramp may extend from an outer surface of the baffle or carrier. The inlet ramp may be any desired angle relative to the outer surface. The inlet ramp may extend at any desired position and may be any desired shape to meet packaging constraints in a given application. However, it is envisioned that the inlet ramp may act as an entrance for the fluid into the downspout and may connect the outer surface (or any other surface) of the baffle to a channel of the downspout.

The channel may function as the primary flow path of the fluid. The channel may receive the fluid from the inlet ramp and guide the fluid towards an outlet. The channel may be formed from one or more walls of the downspout. For example, the channel may be formed by interconnecting opposing walls. The opposing walls may be substantially parallel or may extend at an angle relative to each (e.g., form a taper). Thus, the walls may converge or diverge from one another towards a bottom portion of the channel. Furthermore, as discussed below, the channel may be formed to have any desired size and/or shape.

The channel may ultimately direct a flow of the fluid to an outlet. The outlet may function as an exit for fluid to drain out of the cavity. The outlet may be positioned anywhere along the baffle, such as centrally or along a peripheral edge of the baffle. Centrally positioned outlets may require a hole or aperture through the baffle in which fluid may drain. However, if the outlet is positioned along a peripheral edge, the outlet may no longer require an additional hole or aperture. In such a case, it may be desirable to ensure a gap between the outlet and one or more adjacent panels of the cavity to ensure sufficient space for the fluid to drain out of the cavity through the outlet. To ensure such a gap and/or positioning of the outlet, one or more projections or offsets may be utilized to position the baffle relative to the cavity panels. Similarly, it is envisioned that the outlet is free of contact with the sealant material before and after activation to ensure that the sealant material does not block the outlet of the downspout.

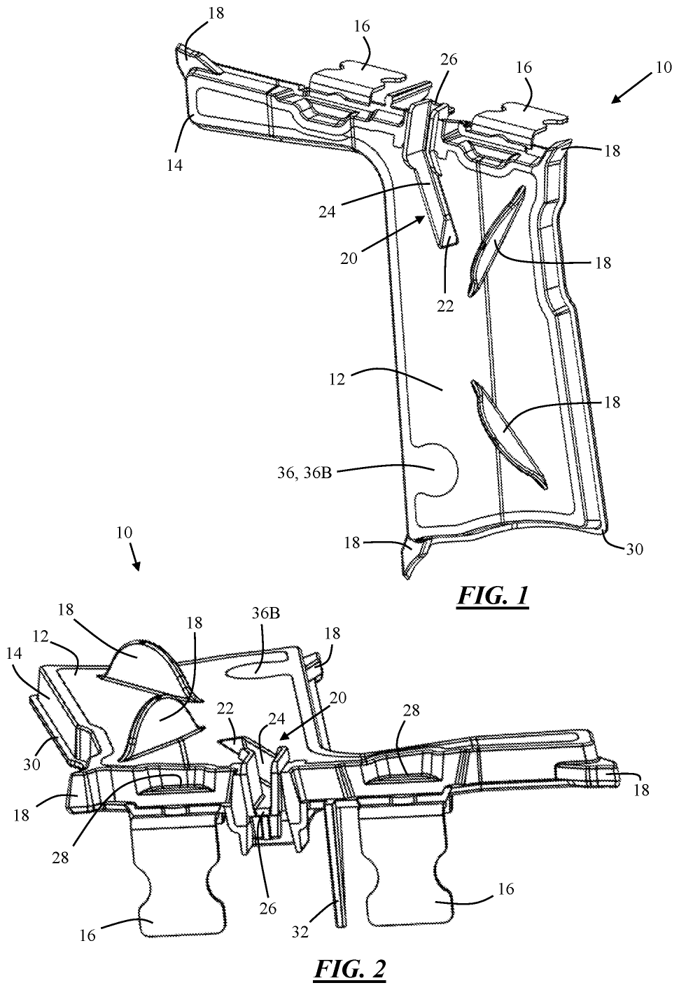

Turning now to the figures, FIG. 1 illustrates a top view of a baffle 10 in accordance with the present teachings. The baffle 10 includes a carrier 12 and a sealant material 14 disposed thereon. As shown, the sealant material 14 may be disposed along a periphery of the carrier 12 so that an inner portion of the carrier 12 is free of a sealant material 14. However, it should be noted that the sealant material 14 may be disposed anywhere along, or on, the carrier 12.

The sealant material 14 may be secured to the carrier 12 by one or more retaining features 36, such as a mechanical interlock 36B that retains the sealant material 14 in a desired position relative to the carrier 12 before installation, during installation, after installation, or a combination thereof. For example, the sealant material 14 may be activatable and the retaining features 36 may maintain a position of the sealant material 14 prior to activation of the sealant material 14.

The sealant material 14 may be supported by a lip 30 of the carrier 12. While the sealant material 14 may extend to a terminal edge of the lip 30, as shown in FIG. 1, the sealant material 14 may also terminate prior to reaching the terminal edge of the lip 30, thereby exposing at least a portion of the lip 30 of the carrier 12. Additionally, the sealant material 14 may be substantially coplanar with an inner portion of the carrier 12. That is, a portion of the carrier 12 substantially bordered by the sealant material 14 may be coplanar with the sealant material 14. However, depending on a given application, the sealant material 14 may also be recessed relative to the carrier 12, extend beyond the carrier 12, or both.

The carrier 12 may also include one or more fins 18 that extend at various angles relative to the carrier 12. For example, the fins 18 may project from a surface of the carrier 12 along an inner portion or the fins 18 may project from a periphery of the carrier 12 near or through the sealant material 14. Thus, it may be gleaned from the present teachings that the fins 18 may extend in any desired direction from the baffle 10.

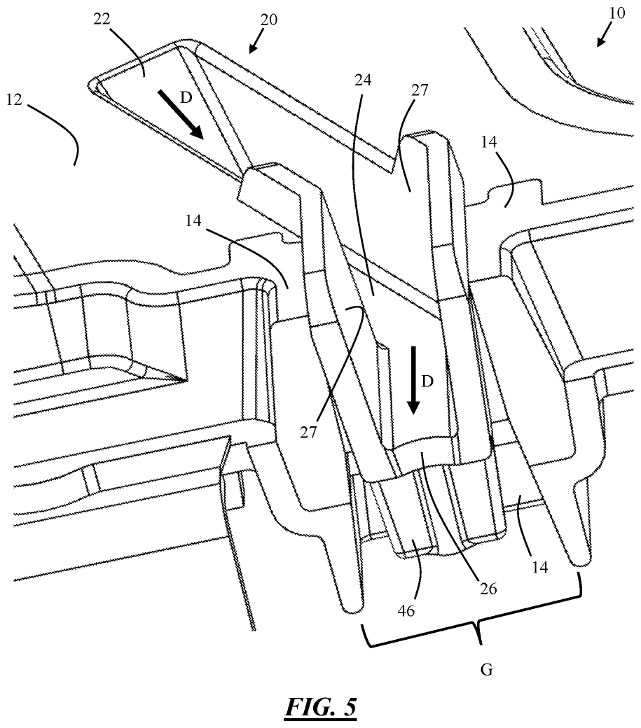

The carrier 12 may also include a downspout 20 formed therein to direct a fluid in a desired direction (see FIG. 5). It is envisioned that the baffle 10 may be positioned within a cavity of a vehicle to seal the cavity, reinforce the cavity, provide noise and/or vibration attenuation, or a combination thereof. Moisture may be present at times within the cavity, such as along a surface of the carrier. As a result, the downspout 20 may provide a means for the moisture to flow through the cavity to drain the cavity of moisture. As illustrated in FIG. 1, the downspout may include an inlet ramp 22 that receives the moisture (not shown) and directs the moisture into a channel 24 of the downspout 20. The moisture flowing through the channel 24 may ultimately reach an outlet 26 of the downspout 20, thereby allowing the moisture to drain out of the cavity. It is envisioned that, when the baffle 10 is secured within the channel by one or more tabs 16 or other fastening means, a gap exists between the outlet 26 of the downspout 20 and walls of the cavity to allow for proper drainage of moisture from the cavity (see FIG. 4).

FIG. 2 illustrates a side view of the baffle 10 of FIG. 1. As discussed above, the baffle 10 may include a sealant material 14 disposed along a periphery of a carrier 10 and secured to the carrier 10 by one or more retaining features, such as a mechanical interlock 36B. However, it should also be noted that the sealant material 14 may be connected to the carrier 10 free of mechanical interlocks. For example, one or more engaging mechanisms, such as one or more extensions (e.g., whiskers), may aid in retention of the sealant material 14 to the carrier 10. Additionally, one or more projections 18 may extend from the carrier 12 or sealant material 14.

Additionally, the baffle 10 may include one or more projections 32 that extend from a bottom or back surface of the baffle 10. The projections 32 may act as a standoff to position the baffle 10 within a cavity relative to one or more panels. Similarly, the projections 32 may at least partially secure the baffle 10 in a desired position, such as by the projections 32 being inserted into a hole or void within a panel of the cavity. Additionally, it is envisioned that the projections 32 may be configured to position and/or locate the baffle 10 during a manufacturing process. For example, the projections 32 may align the baffle 10 with a manufacturing fixture to ensure that the baffle 10 is properly positioned during automated movement of the baffle 10, such as by robotic assembly processes.

The baffle 10 may also include a downspout 20 integrally (i.e., monolithically) formed with the carrier 12 of the baffle 10. The downspout 20 may include an inlet ramp 22 that funnels moisture or fluid into a channel 24 of the downspout, ultimately directing the moisture or fluid out of the cavity—or off a surface of the baffle 10—through an outlet 26. It is envisioned that the downspout 20 may be positioned along a peripheral edge of the baffle 10 so that the outlet 26 is formed along a terminal edge of the baffle 10. However, the downspout 20 may also be positioned more centrally along the baffle 10 so that the outlet 26 is formed therein, such as hole centrally located through the baffle 10.

Similarly, the downspout 20 may be located anywhere along the periphery of the baffle 10. As shown in FIG. 2, the downspout 20 may be positioned between tabs 16 of the baffle 10 so that the downspout 20 is located adjacent to a desired portion of a cavity (see FIG. 4). Similarly, the downspout 20 may also be positioned between steps 28 of the carrier 12, the sealant material 14, or both. The steps 28 may be configured to decrease material weight and/or cost, increase structural integrity, follow a contour of a cavity, or a combination thereof. However, it should also be noted that the downspout 20 may be positioned away from the tabs 16, such as along an opposing side of the baffle 10.

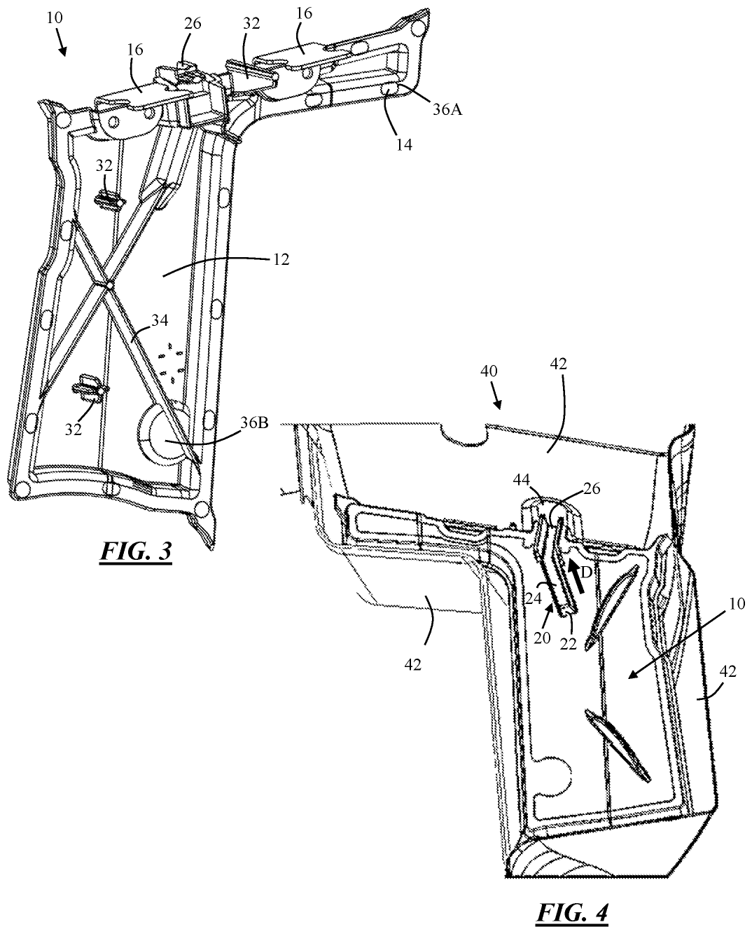

FIG. 3 is a bottom view of a baffle 10 in accordance with the present teachings. As discussed above, the baffle 10 may include a downspout with an outlet 26 along a peripheral edge of the baffle 10 that extends from an upper surface of the baffle 10 between opposing tabs 16 of the carrier 12. Additionally, the carrier 12 may include one or more projections 32 that extend from the bottom surface away from the carrier 12. The projections 32 may vary in size and/or shape.

Moreover, the carrier 12 may include one or more ribs 34 that help increase structural integrity of the baffle 10. The ribs 34 may also project from the bottom surface of the carrier 12. The ribs 34 may intersect one another. Additionally, the ribs 34 may have a length—as measured from the bottom surface of the carrier 12 in a direction of projection of the ribs 34—substantially equal to a depth of the lip of the carrier 12. However, the ribs 34 may also have a length greater than a depth of the lip, less than a depth of the lip, or both.

The sealant material 14 may be secured the carrier 12 by one or more retaining features. For example, as discussed above, a mechanical interlock 36B may exist between the carrier 12 and the sealant material 14. Similarly, the sealant material 14 may also be secured to the carrier 12 by one or more holes 36A in the carrier 12. The sealant material 14 may at least partially extend through the hole 36A or be oversized relative to the hole 36A to engage the hole 36A. Additionally, such holes 36A may also direct the sealant material 14 during activation if desired (i.e., during expansion and/or flow of the sealant material 14) to further engage the sealant material 14 and the carrier 12.

FIG. 4 illustrates a baffle 10 positioned within a cavity 40. The cavity 40 may be any cavity 40, such as one found in a vehicle body. As illustrated, the baffle 10 may substantially follow a contour of the cavity 40 formed by a plurality of interconnecting panels 42. As discussed above, a periphery of the baffle 10 may include an activatable material the substantially aligns with the cavity panels 42 so that, upon activation of the activatable material, the baffle 10 seals the gaps between the cavity 40 (i.e., the panels) and the baffle 10.

A downspout 20 of the baffle 10 may be positioned to direct a flow of moisture or liquid within the cavity 40 in a desired direction (D) out of the cavity 40 and/or off a surface of the baffle 10. For example, the fluid or moisture may enter the downspout 20 along an inlet ramp 22, flow through a channel 24, and out of an outlet 26 of the downspout 20.

The outlet 26 may be positioned along an edge of the baffle 10 to at least partially align with, or be adjacent to, a desired panel 42 of the cavity 40. It is envisioned that the outlet 26 may be positioned to have at least a localized gap between the outlet 26 and the panel 42 to ensure the moisture or fluid is able to flow out of the cavity 40 or off the surface of the baffle 10. For example, as shown in FIG. 4, the panel 42 may include an embossment 44 or divot that provides additional localized clearance between the panel 42 and the outlet 26, thereby ensuring proper drainage of the moisture or fluid.

FIG. 5 is a close-up perspective view of a downspout 20 in accordance with the present teachings. As discussed above, the baffle 10 may include a downspout 20 formed along a carrier 12 of the baffle 10. It is envisioned that the downspout 20 may be integrally formed with the baffle 10. However, the downspout 20 may also be a connected piece if needed.

The downspout 20 may include an inlet ramp 22 that extends from an outer surface of the baffle 10 towards a channel 20 of the downspout 20. The inlet ramp 22 may be at any desired angle relative to the outer surface of the baffle 10 to ensure a desired flow direction. It is contemplated that the inlet ramp 22 may extend between the outer surface of the baffle 10 and the channel 24.

The channel 24 may be formed from opposing interconnected walls 27. The walls 27 may be substantially parallel to each other, or may extend away from or towards one another (i.e., tapered). The interconnected walls 27 may form a U-shaped channel, V-shaped channel, C-shaped channel, or any other desired shaped channel 24. Moreover, the channel 24 may extend towards an outlet 26 of the downspout 20 to ensure moisture or fluid flows in a desired direction (D) through the downspout.

Furthermore, to ensure proper drainage, a gap (G) may exist along the sealant material 14 where the downspout outlet 26 is located. The gap (G) may be a break in the sealant material 14 to ensure that a portion around the outlet 26 is free of sealant material 14 after activation of the sealant material 14, thereby ensure fluid or moisture may still properly drain through the outlet 26.

Similarly, the downspout 20 may include an extension 46 extending away from (i.e., down) the downspout 20. The extension 46 may be positioned between the sealant material 14 and the outlet 26 of the downspout 20 to ensure that, when the sealant material 14 is activated, expansion and or flow of the sealant material 14 is prohibited from intruding on the outlet 26. As a result, the extension 46 may prevent unwanted blockage of the outlet 26 to ensure proper drainage of moisture or fluid through the downspout 20. For example, as illustrated in FIG. 5, the sealant material 14 is at least partially recessed from the outlet 26 and the extension 46 is located between the recessed portion of the sealant material 14 and the outlet 26. As a result, the sealant material 14 may be directed away from the outlet 26 by the extension 46 during activation, thereby ensuring the outlet 26 remains entirely or substantially free of the sealant material 14. However, it is also contemplated that while the extension 46 may prevent blockage of the outlet 26, the extension 46 may still advantageously allow the sealant material 14 to properly flow and/or expand to adhered to an interfacing surface (e.g., sheet metal of a vehicle).

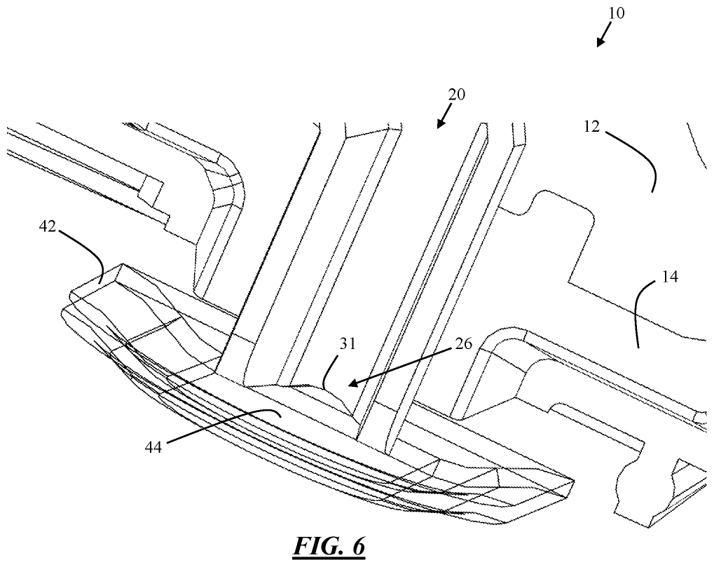

FIG. 6 illustrates the downspout 20 of FIG. 5 interaction with a panel 42 of a vehicle or other device. As discussed above, the baffle 10 may include an adhesive material 14 secured to a carrier 12 of the baffle 10. The sealant material 14 may be configured to, upon activation, flow and/or expand to engage the panel 42. As a result, the sealant material 14 may adhere to the panel 42 and seal any gap between the baffle 10 and the panel 42 in desired areas determined by a flow and/or expansion path of the sealant material 14. However, it is envisioned that an outlet 26 of the downspout 20 may be free of the sealant material 14 after activation to ensure proper draining of the moisture or fluid through the downspout 20. This may be facilitated by an extension as discussed in relation to FIG. 5.

Similarly, the outlet 26 of the downspout 20 may also include a scallop 31 to ensure proper draining of the moisture or fluid through the out downspout 20. The scallop 31 may be a notched or recessed portion of the downspout 20. A length (i.e., distance) from the inlet ramp of the downspout 20 to the scallop 31 may be less than an overall length measured from the inlet ramp to a portion of the outlet 26 other than the scallop 31 (i.e., an overall length of the outlet 20). As a result, the scallop 31 may beneficially account for contact between the outlet 26 and the panel 42 and ensure a gap is maintained between the panel 42 and the outlet 26, thereby ensuring proper drainage of the moisture or fluid. Moreover, to further ensure proper draining, the panel 42 may include an embossment 44 that aligned with the outlet 26 to provide a greater gap between the outlet 26 and the panel 42.

### ELEMENT LIST

10 Baffle
12 Carrier
14 Sealant Material
16 Tab
18 Fin
20 Downspout
22 Inlet Ramp
24 Channel
26 Outlet
27 Wall
28 Step
30 Lip
31 Scallop
32 Projection
34 Rib
36 Retaining Feature
36A Hole
36B Mechanical Interlock
40 Cavity
42 Panel
44 Embossment
46 Extension
G Gap of the Sealant Material
D Flow Direction

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100+/−15.

The preferred embodiment of the present invention has been disclosed. A person of ordinary skill in the art would realize however, that certain modifications would come within the teachings of this invention. Therefore, the following claims should be studied to determine the true scope and content of the invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

What is claimed is:

1. A baffle, comprising:
(a) a carrier having a downspout to direct a flow of moisture or fluid; and
(b) a sealant material disposed on the carrier;
wherein the downspout is located near a peripheral edge of the carrier and the downspout is free of contact with the sealant material.

2. The baffle of claim 1, wherein sealant material is activatable and the downspout is free of contact with the sealant material after activation of the sealant material.

3. The baffle of claim 2, wherein the downspout includes:
(a) an inlet ramp;
(b) a channel in communication with the inlet ramp; and
(c) an outlet located along the peripheral edge of the carrier in communication with the inlet ramp.

4. The baffle of claim 3, wherein a flow direction of the moisture or the fluid is from the inlet ramp through the channel so that the moisture or the fluid drains from the outlet.

5. The baffle of claim 4, wherein the sealant material is located along a periphery of the carrier and is free of contact with a central portion of the carrier.

6. The baffle of claim 5, wherein the sealant material is expandable upon activation.

7. The baffle of claim 6, wherein the baffle is configured to be positioned within a cavity and seal the cavity.

8. The baffle of claim 7, wherein a shape of the baffle substantially follows a contour of the cavity.

9. The baffle of claim 8, wherein the carrier further includes a weldable tab.

10. The baffle of claim 9, wherein the downspout is formed by interconnecting opposing walls.

11. The baffle of claim 10, wherein the opposing walls are substantially parallel to each other.

12. The baffle of claim 10, wherein the opposing walls are angled relative to each other to form a taper.

13. The baffle of claim 12, wherein the taper narrows along a bottom portion of the downspout away from an outer surface of the baffle.

14. The baffle of claim 10, wherein the downspout is positioned within a gap of the sealant material, wherein the gap is a break in a section of the sealant material.

15. The baffle of claim 14, wherein the downspout is positioned between weldable tabs and between steps formed in the carrier.

16. The baffle of claim 15, wherein the sealant material is secured to the carrier by one or more retaining features.

17. The baffle of claim 16, wherein the one or more retaining features is a mechanical interlock.

18. The baffle of claim 16, wherein the one or more retaining features is a hole having the sealant material at least partially extend therethrough.

19. The baffle of claim 16, wherein the downspout is configured to be offset from a panel of a cavity to ensure proper drainage of the moisture or the fluid.

20. The baffle of claim 16, wherein the carrier includes intersecting ribs along a back surface of the carrier.
